(19) United States
(12) Patent Application Publication
(10) Pub. No.: US 2005/0213841 A1
(43) Pub. Date: Sep. 29, 2005

(54) Image processing

(76) Inventors: Marius George Linguraru, Sophia Antipolis Cedex (FR); John Michael Brady, Oxford (GB)

Correspondence Address: NIXON & VANDERHYE, PC, 901 NORTH GLEBE ROAD, 11TH FLOOR, ARLINGTON, VA, 22203, US

(21) Appl. No.: 10/518,721

(22) PCT Filed: Jun. 20, 2003
(86) PCT No.: PCT/GB03/02686

§ 371 Date: Dec. 21, 2004

(30) Foreign Application Priority Data
Jun. 21, 2002 (GB) 0214397.2
Sep. 23, 2002 (GB) 0222066.3

(51) Int. Cl. G06K 9/40; G06K 9/00

(52) U.S. Cl. 382/261; 382/128

(57) ABSTRACT

Image processing method, particularly suitable for processing noisy images such as digitised mammograms. An adaptive anisotropic diffusion processing method is described in which the diffusion parameter is adjusted in accordance with the contrast in the image. An adaptive foveal segmentation method is also described in which the segmentation parameters are set adaptively in accordance with the contrast in the image.

The present invention relates to image processing and, in particular, to the enhancement of images to assist in their interpretation.

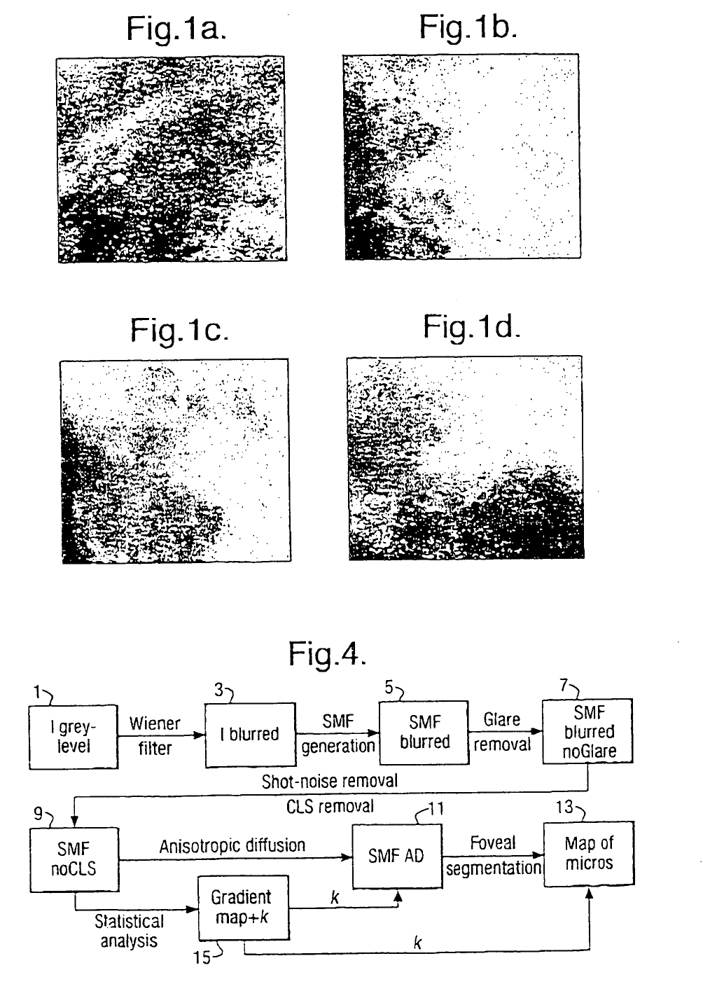

There are many techniques for the processing of images, particularly digitised images, to reduce noise and assist in their interpretation. Such techniques are particularly important in the field of medical imaging, where images are typically noisy and difficult to interpret since clinically significant signs are mostly subtle. As an example, x-ray imaging is used as a basis for many medical techniques and, in particular, mammography is currently the examination of choice for early detection of breast cancer. One of the earliest indicators of breast cancer is the presence of microcalcifications, which can often be identified in mammograms as localized bright spots. In the accompanying drawings FIG. 1 illustrates some mammogram samples showing microcalcifications. FIGS. 1A and B show isolated calcifications, while FIGS. 1C and D show microcalcification clusters. It would be useful to have image enhancement techniques which assist radiologists or clinicians in finding microcalcifications in mammogram images. However, it is important that such techniques miss as few clinically important microcalcification clusters as possible, and also do not signal too many false positives.

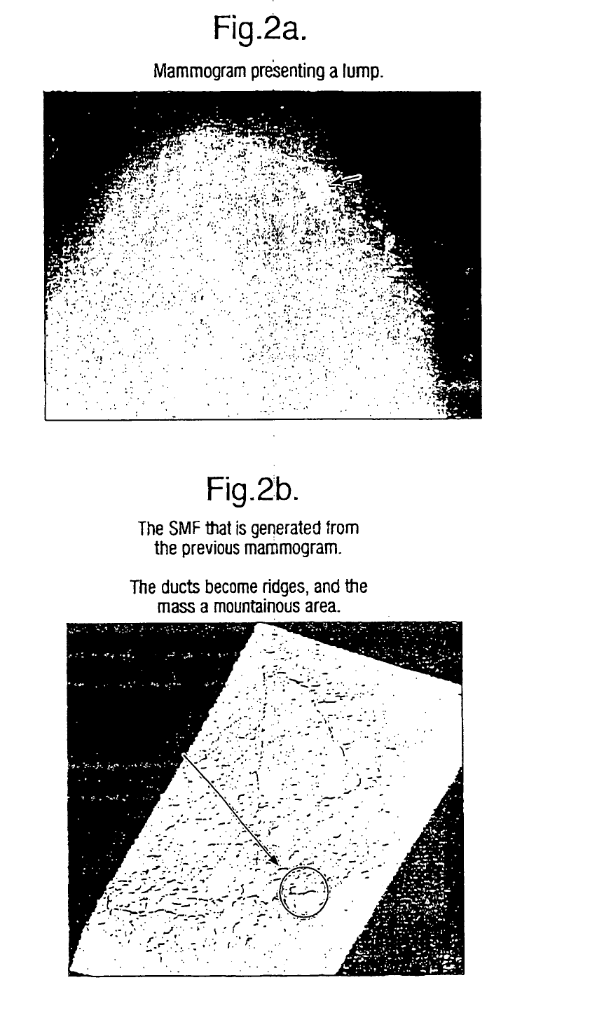

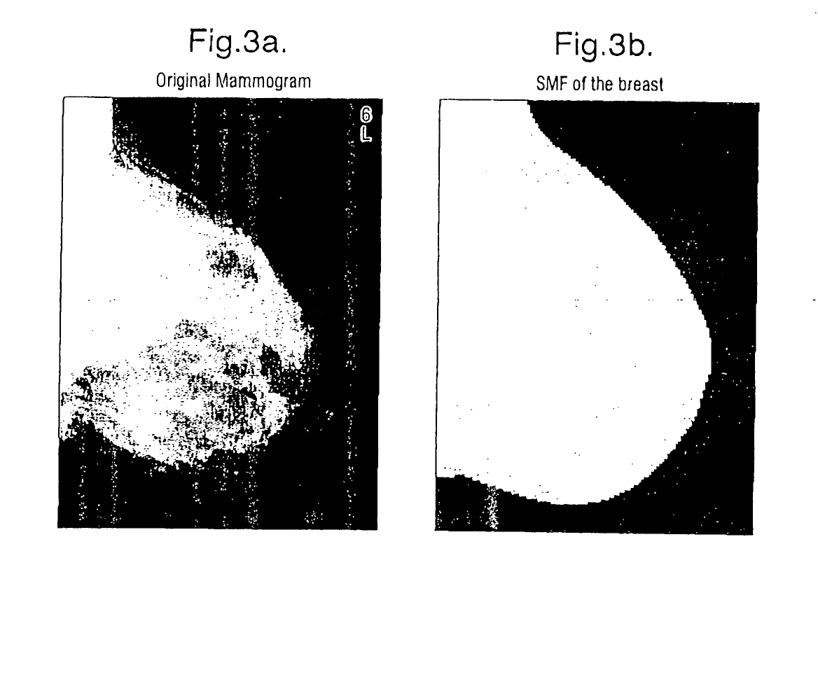

Methods of detecting automatically microcalcifications in mammograms have been proposed, for instance in WO-A-00/52641 and WO-A-01/69533. These techniques are based on an adapted version of the image known as the hᵢₙₜ representation in which the specific imaging parameters particular to the imaging process are removed. This results, in essence, in a normalised image known as the Standard Mammogram Format (SMF) which can be displayed as an hᵢₙₜ surface, or with the hᵢₙₜ values converted into grey levels, in which case the image resembles a conventional mammogram. The techniques for producing the hᵢₙₜ representation will not be repeated here, but they are explained in detail in WO-A-00/52641 which is incorporated herein by reference. FIGS. 2 and 3 of the accompanying drawings illustrate respectively an original mammogram and the different hᵢₙₜ or SMF representations. In FIG. 2 the hᵢₙₜ values are shown as a surface whereas in FIG. 3 the hᵢₙₜ values are converted into grey levels and displayed as an SMF akin to a conventional mammogram.

One technique for enhancing images is known as “diffusion”. This is, in essence, a smoothing process in which the image is processed by convolving the intensity values in the image with a kernel for instance a Gaussian kernel. Although such a smoothing process can assist in enhancing images, it can also create problems. In particular, in an image containing an object shown against a background, smoothing or blurring of the object into the background is undesirable. Therefore so called “anisotropic diffusion” techniques have been proposed in which the diffusion processing occurs within objects, and within the background, but not across the boundaries between the two. Such techniques are disclosed, for instance, in “Scale-Space and Edge Detection Using Anisotropic Diffusion” by Perona and Malik (IEEE Transactions on Pattern Analysis and Machine Intelligence, volume 12, number 7, July 1990) and “Robust Anisotropic Diffusion” by Black et al. (IEEE Transactions on Image Processing, volume 7, number 3, March 1998) which are incorporated herein by reference. In these techniques, though, the parameters of the diffusion process which include the number of iterations, the scale of the kernel and the diffusion coefficient itself, are typically set interactively by the user. This would be impractical for medical image processing in which many images of different qualities and characteristics are produced, thus requiring the automatic setting of parameters for each individual image.

The first aspect of the present invention provides a method of processing mammogram images using an anisotropic diffusion process in which the anisotropic diffusion process is adaptive in dependence upon the image being processed. The process adapts itself in accordance with the characteristics of the image, eg a measure of the contrast in the image. This adaptation is automatic, and thus does not require the user to assess the image and set the diffusion process parameters for each different type of image.

The diffusion process may be made adaptive by changing its parameters, e.g. its diffusion coefficient, and/or, for example, the number of iterations in the process. For example, the diffusion coefficient may be dependent upon the contrast in the image. In particular it may be calculated from a statistical analysis or measure of the local contrast in the image, e.g. based on an average value and standard deviation of the local contrast values.

Thus the invention involves taking an original image, possibly processing it to enhance it using known techniques, such as in a mammogram to produce the Standard Mammogram Format, possibly performing other enhancements such as taking the Gaussian derivative, and then applying an anisotropic diffusion process in which at least one of the parameters of the diffusion process are calculated from the characteristics of this particular image.

It is found that this technique allows the application of anisotropic diffusion processing to many different images, e.g. different mammograms, on an automated basis. In the case of mammograms it provides enhancement of the visibility in the processed image of microcalcifications.

Another aspect of the invention provides a method of segmenting an object in an image from the background of the image by using a contrast based segmentation method, such as a so-called foveal segmentation algorithm, in which the segmentation algorithm is made adaptive by being dependent upon the characteristics of the image being processed, such as the contrast.

Foveal segmentation is a segmentation based on the local contrast in areas of the image. It is based on an analysis of human brightness perception as explained in “A New Image Segmentation Method Based on Human Brightness Perception and Foveal Adaptation” by Heucke et al (IEEE Signal Processing Letters, volume 7, number 6, June 2000). In the technique described in that paper, areas of an image are assigned to belong to either an object or the background depending on whether the local contrast is above a certain minimum contrast. The minimum contrast is calculated to be the minimum contrast perceivable by the human eye. With this aspect of the present invention, however, the segmentation technique is developed so that at least one of the parameters of the segmentation process is calculated from the image characteristics. This allows the automatic segmentation of images of different characteristics without the need for the user interactively to set the segmentation parameters. Conveniently the minimum contrast value is defined with respect to the contrast in the image, for instance a statistical analysis or measure of the local contrast in the image, e.g. based on an average value and standard deviation of the local contrast values.

The two aspects of the invention may be combined together and they are particularly useful for processing medical x-ray images, particularly digitised mammograms.

The invention also extends to a computer program comprising program code means for executing the image processing method on a suitably programmed computer system, to a computer readable storage medium carrying the computer program, and to an image processing apparatus for executing the image processing method.

The invention will be further described by way of example with reference to the accompanying drawings in which:—

FIGS. 1A to D illustrate mammograms including microcalcifications;

FIGS. 2A and B illustrate respectively a mammogram and its Standard Mammogram Format;

FIGS. 3A and B illustrate a mammogram and its Standard Mammogram Format;

FIG. 4 is a flow diagram illustrating image processing according to one embodiment of the present invention;

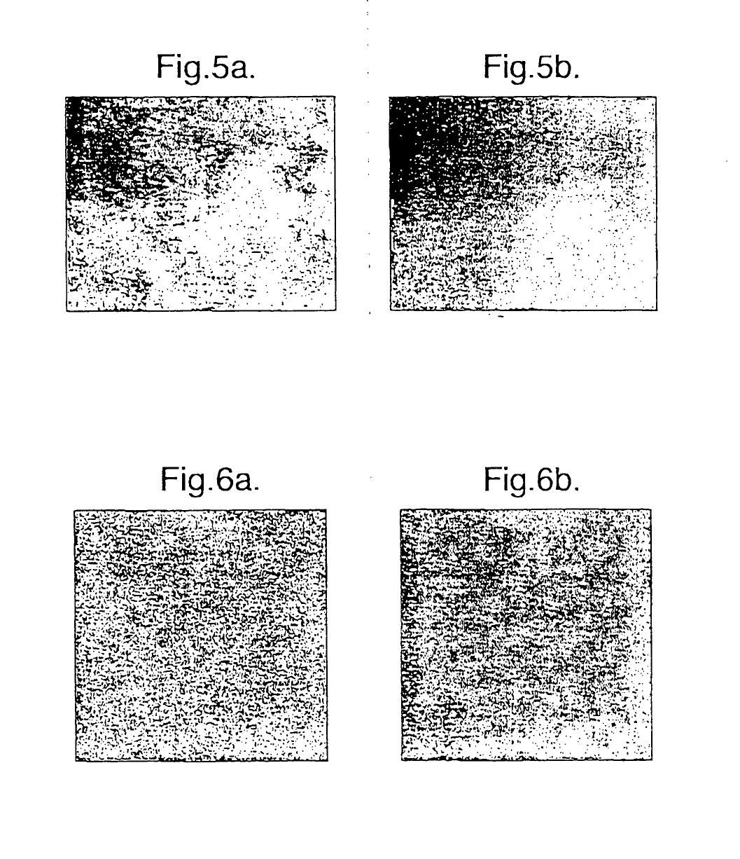

FIG. 5A shows an example of a mammogram containing a large calcification and several artifacts and

FIG. 5B illustrates the result of diffusing the image of FIG. 5A;

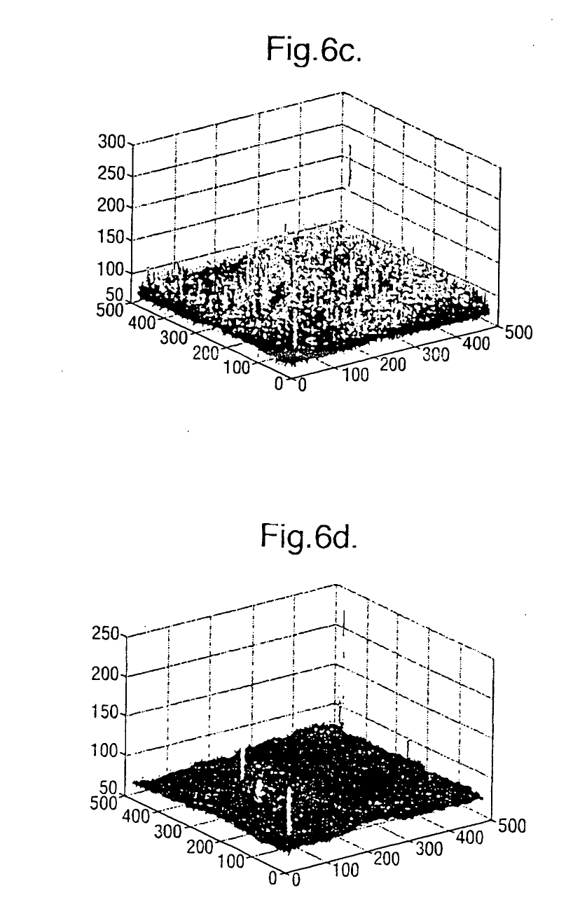

FIG. 6A illustrates an SMF image containing a microcalcification,

FIG. 6B the diffused conversion of image A,

FIG. 6C a 3-D plot of the SMF image of FIG. 6A, and

FIG. 6D the surface of the diffused image in FIG. 6B;

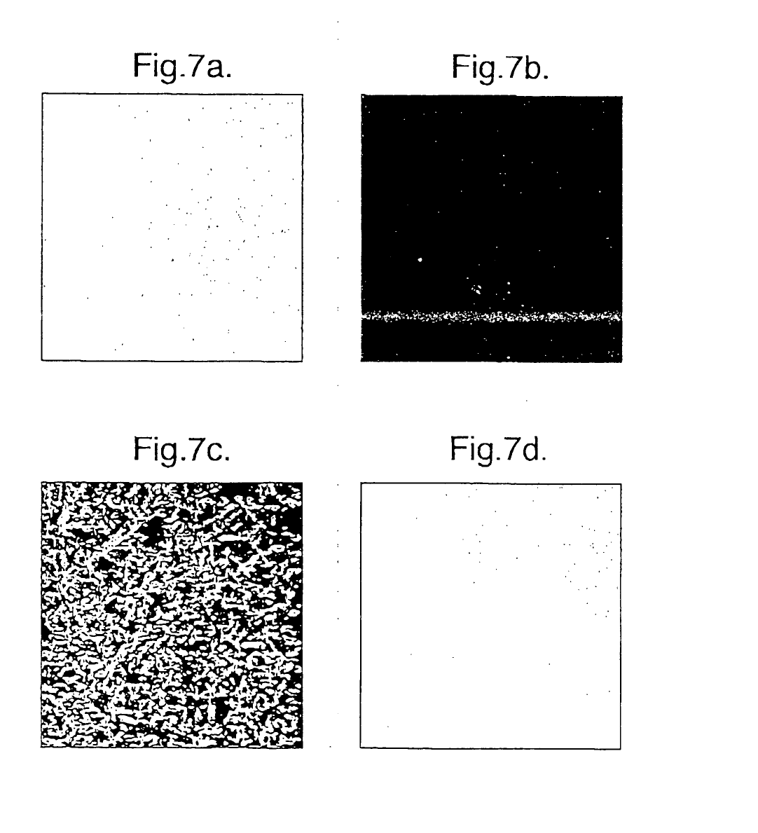

FIGS. 7A through D illustrate the removal of artifact from a mammogram, namely successively: FIG. 7A illustrates the original image, FIG. 7B a map of the shot-noise, FIG. 7C a map of curvilinear structures in the image and FIG. 7D the image after shot-noise and curvilinear structure removal;

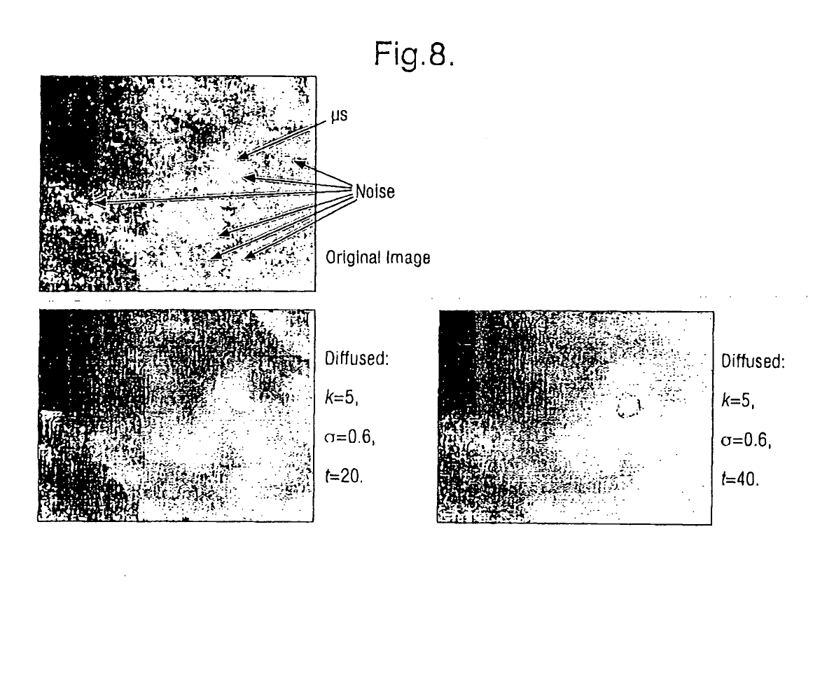

FIG. 8 illustrates an original image and diffused versions of the image with different parameters;

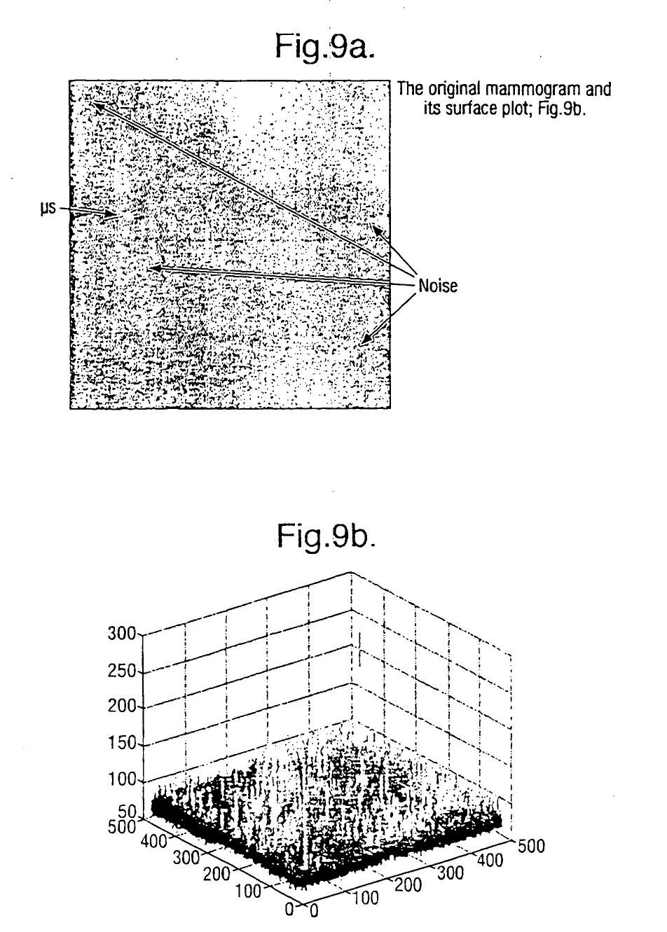

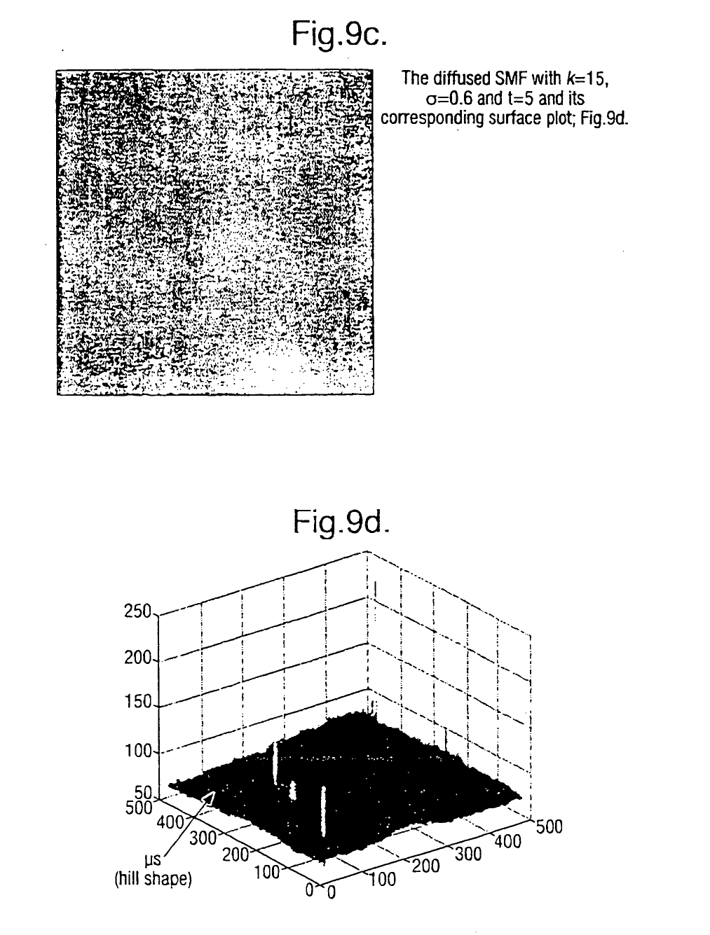

FIG. 9 illustrates an original mammogram and its surface plot together with diffused versions of the mammogram and surface plot;

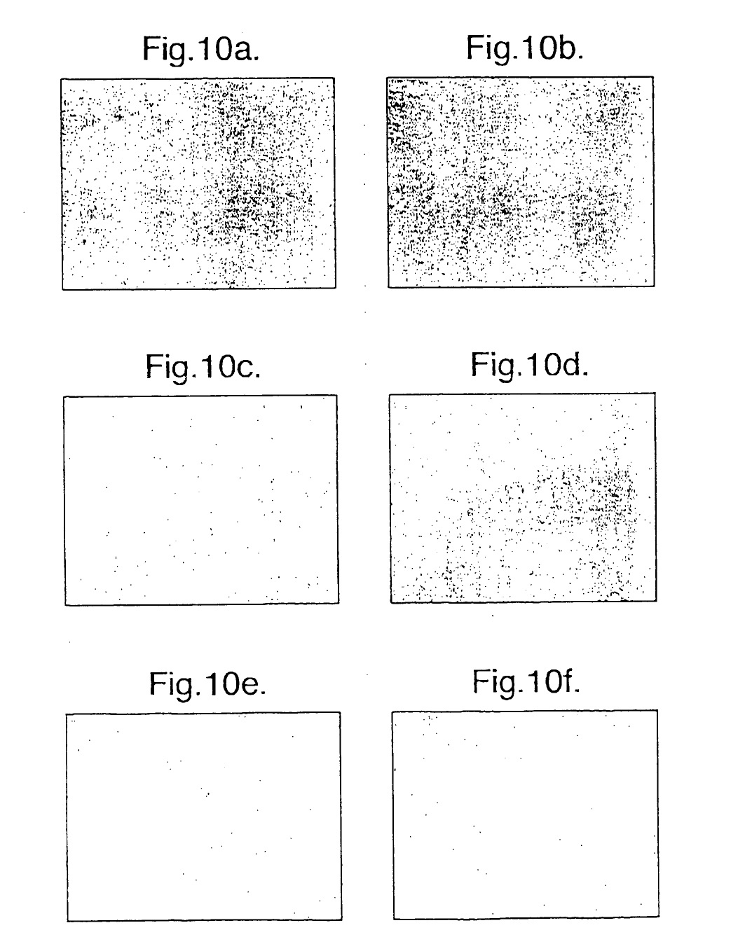

FIGS. 10A and B illustrate original images with calcifications,

FIGS. 10C and D illustrate gradient maps for the images of FIGS. 10A and B and

FIGS. 10E and F illustrate diffused versions of the images of FIGS. 10A and B;

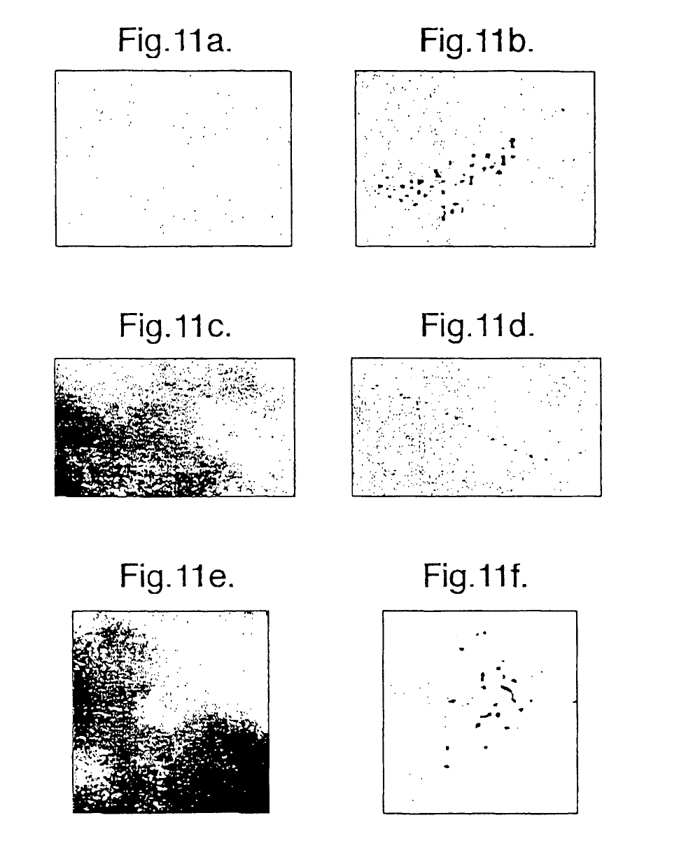

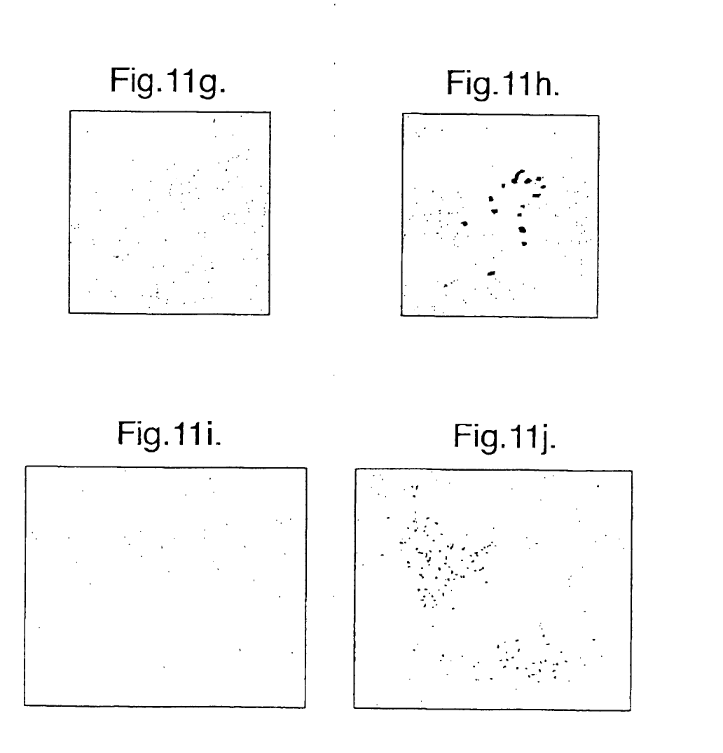

FIGS. 11A through J illustrate original SMF images alongside corresponding processed images in which the microcalcifications have been detected and marked in accordance with an embodiment of this invention.

FIG. 4 is a flow diagram of image processing in accordance with one embodiment of the invention. In is embodiment the processing according to the invention is preceded by processing which has previously been proposed to enhance the image.

The grey-level original image 1 is first blurred using a Wiener filter. This de-noises the image to an extent by removing radiographic mottle, which is a source of false positives in detecting microcalcifications. The Wiener filter is adapted to the characteristics of radiographic noise in the original image. This technique is explained in Yam, M. Brady, J. M. Highnam, R. P. English R.: Denoising hᵢₙₜ Surfaces: a Physics-based Approach, in Medical Image Computing and Computer-Assisted Intervention 1999, Springer-Verlag, Berlin Heidelberg New York (1999) 227-234, incorporated herein by reference.

The next step is the generation of the Standard Mammogram Format (SMF) 5 using the technique described in WO-A-00/52641.

This may be further processed by the glare removal technique disclosed in WO-A-00/52641 to produce the blurred, no glare, SMF 7.

A major source of errors in detecting microcalcifications is film-screen shot noise, which appears primarily from small pieces of dust on the intensifying screen and has visual properties which are similar to those of microcalcifications. However, because shot noise is caused, for example, by dust on the screen rather than by structures within the breast, it is characterised by the absence of blur. Therefore such shot noise may be detected by the absence of blur, and then removed from the image. This technique is described in Highnam, R. P. Brady, J. M. English, R.: Detecting Film-Screen Artifacts in Mammography using a Model-Based Approach, in IEEE Transactions in Medical Imaging, Vol. 18 (1999) 1016-1024 which is herein incorporated by reference. Further, curvilinear structures in the breast have similar visual properties to microcalcifications when viewed in a noisy image. It is advantageous, therefore, to use one of the available techniques for the removal of curvilinear structures, for example based on phase congruency as disclosed in Yates, K. Evans, C. J. Brady, J. M.: Improving the Brake's Mammographic Mass Detection Algorithm Using Phase Congruency, in Proceedings of Digital Image Computing: Techniques and Applications, Melbourne (2002), which is herein incorporated by reference.

This results in an enhanced SMF 9. FIG. 7 illustrates this artifact removal process. FIG. 7A illustrates the original image and FIG. 7B the shot-noise map (white dots are noise). FIG. 7C illustrates the curvilinear structure map, and FIG. 7D the “clean” image after shot-noise and CLS removal.

Next, in accordance with the invention, the clean SMF 9 is subjected to an adaptive anisotropic diffusion process to produce a diffused image 11, and then to adaptive foveal segmentation to produce a map of microcalcifications 13. These processes are rendered adaptive by using a parameter k which is representative of the local contrast in the image. This parameter is derived from a gradient map 15 whose calculation will be described below.

The parametric format of anisotropic diffusion makes it highly dependent upon the fine-tuning of its input parameters. There are three parameters to be considered when attempting to blur an image using anisotropic diffusion: k—the contrast, t—the time or number of iterations and σ—the standard deviation or scale. In practice, the more complex and variable the image is in a data set, the more problematic it is to choose a single set of values for these parameters that work well for the entire data set. Medical images, and certainly mammograms, are very complex images whose appearance varies widely across a population (at a centre, hospital, region, country or continent), which makes the vital requirements of generating few false positives and fewer false negatives very difficult.

In accordance with this embodiment of the present invention the contrast parameter k, which is image dependent, is varied in dependency upon the characteristics of the image. The time parameter t is set to be constant (i.e. a constant number of iterations), as is the scale.

In accordance with this embodiment of the invention the adaptive anisotropic diffusion is conducted with parameters, in particular a contrast value, derived from use of a Gaussian derivative filter. Firstly, the SMF 9 is processed to derive the Gaussian derivative of the image in accordance with equations 2 and 3 below:—

$$\begin{matrix}{K}_{σ} ( I ) = \frac{1}{2 {πσ}^{2}} * exp ( - \frac{{\vert I \vert}^{2}}{2 {σ}^{2}} ) & ( 2 ) \\ M = \vert {K}_{σ}^{′} ( I ) \vert & ( 3 )\end{matrix}$$

where K is the Gaussian of image I and M the Gaussian derivative.

Then the values of the local contrast gᵢ are calculated for the image in accordance with equation 4 below:—

$${g}_{i} = {M}_{t} - \frac{1}{N} {\sum }_{j ∈ {δ}_{t}} {M}_{j} \qquad ( 4 )$$

The local contrast is calculated in a neighbourhood of N pixels. These values g, may be displayed in a gradient map as shown in FIG. 10 in which FIGS. 10A and B are images including respectively an isolated calcification and a microcalcification cluster, and FIGS. 10C and D are the corresponding gradient maps. It can be seen that the calcifications are more visible in the gradient maps.

In this embodiment a computed contrast value k is then calculated from the gradient map for the image in accordance with equation 5 below. This value is set to be the average value of the local contrasts plus two standard deviations. This value will be subsequently used in the anisotropic diffusion process and also in the foveal segmentation process.
k=mean(g)+2*std(g) (5)

Having calculated the value k an anisotropic diffusion process is applied to the clean SMF 9. This involves applying a diffusion tensor similar to that disclosed in Weickert, I.: Anisotropic Diffusion in Image Processing. B. B. Teubner, Stuttgart (1998) herein incorporated by reference, but using the eigenvalues below:—

$${λ}_{1} = 1 for \vert {gradI}_{σ} \vert = 0$$

$${λ}_{1} = 1 - exp ( \frac{- 1}{{( \vert {gradI}_{σ} \vert / k )}^{n}} ) for \vert {gradI}_{σ} \vert > 0$$

$${λ}_{2} = 1$$

where I is the initial image, I_{σ} the Gaussian smoothed image, k the calculated contrast measure and n is a suitably high power such as δ or 12. It can be seen that where k is high, i.e. where the contrast is high, thus indicative of an edge, the value of the exponential term in π₁ is very small, thus inhibiting diffusion across the edge.

FIG. 8 illustrates an example of an original image and diffused versions of it using k=5, σ=0.6 and firstly t=20 iterations and secondly t=40 iterations. It can be seen that the microcalcification and also noise are more visible in the diffused images. FIGS. 9A and B illustrate an original mammogram in FIG. 9A and its surface plot in FIG. 9B, together with a diffused SMF of the mammogram in FIG. 9C and its corresponding surface plot in FIG. 9D. In this case the diffusion was conducted with k=15, σ=0.6 and t=5 iterations.

FIGS. 5 and 6 also illustrate image diffusion. FIG. 5A illustrates a sample of a mammogram containing a large calcification and several artifacts. FIG. 5B shows the result of diffusing the image and the smooth background and calcification can be clearly distinguished. In FIG. 6, FIG. 6A is an SMF image containing a microcalcification on the left side and a large spot of noise on the lower right side. FIG. 6B is a diffused version of FIG. 6A and FIG. 6C is the 3-D plot of the SMF image in FIG. 6A. The surface plot shows an extremely noisy appearance and important structures can barely be distinguished. However, in FIG. 6D the surface of the diffused image of FIG. 6B is shown and the microcalcification appears as a hill with smoother edges than those of the very sharp-edged noise structures in the same image, while the background is smooth. Therefore the important structures can be distinguished more easily.

The final step in the process illustrated in FIG. 4 is the application of an adaptive segmentation method, such as the foveal method explained by Heucke et al. This processing is conducted upon the diffused SMF image 11. A set of mean values of the image intensities/values is computed using masks for the inner area, its neighbourhood and background. The histogram of the inner surface provides the mean of the values in the object (μₒ) and the histogram of the whole image gives the mean of the background values (μ_{B}). The mean of the values in the neighbourhood (μ_{N}) is defined as the weighted sum of intensities with a suitable scale set for the mask. Then the perceivable contrast is:—

$$C = \frac{\vert {μ}_{o} - {μ}_{N} \vert}{{μ}_{N}}$$

Then a minimum contrast value is computed where μ_{A}=W•μ_{N}+(1−w)•μ_{B} where w is a suitable weight between 0 and 1. In practice w=0.923 gives good results. Thus Cₘᵢₙ is calculated in accordance with equation 7 below:—

$${C}_{min} = \frac{{c}_{w}}{{μ}_{N}} {( b + \sqrt{{μ}_{A}} )}^{2} , {μ}_{A} \geq {μ}_{N}$$

$${C}_{min} = \frac{{c}_{w}}{{μ}_{N}} {( b + \sqrt{\frac{{μ}_{N}^{2}}{{μ}_{A}}} )}^{2} , {μ}_{A} < {μ}_{N}$$

with c_{w} set to \sqrt{k/200}. In practice the value b=0.0808 has given good values. Thus the segmentation process is based on the value of k, calculated from the gradient map and so adapted to the particular image being processed. Areas where C>Cₘᵢₙ are marked as microcalcifications.

FIG. 11 illustrates various original SMF images in FIGS. 11A, C, E, G and I, with corresponding detection maps in FIGS. 11B, D, F, H and J. The marked areas are those areas where the contrast C is greater than minimum contrast Cₘᵢₙ. It can be seen, therefore, that the microcalcification are clearly visible in the segmented map 13 illustrated in FIGS. 11B, D, F, H and J.

Although the invention has been described in relation to the processing of mammograms and in particular the processing of mammograms in the Standard Mammogram Format, it should be appreciated that the techniques are applicable to mammograms which are not in that format, and also to other images, medical or non-medical.

The invention also extends to a computer program for executing the image processing method on a suitably programmed computer system, to a computer readable storage medium carrying the computer program, and to an image processing apparatus for executing the image processing method.

1-15. (canceled)

16. A method of processing images, comprising applying an anisotropic diffusion process to the image, the anisotropic diffusion process being adapted in dependence upon the contrast in the image.

17. A method according to claim 16 wherein a diffusion coefficient in the anisotropic diffusion process is adapted in dependence upon the contrast in the image.

18. A method according to claim 17 wherein the diffusion coefficient is calculated from the local contrast in the image.

19. A method according to claim 18 wherein the diffusion coefficient is calculated from an average value of the local contrast in the image.

20. A method according to claim 16 further comprising the steps of deriving a Gaussian derivative of the image and applying said anisotropic diffusion process to the SMF image.

21. A method of processing images to segment objects in the image from background comprising applying a foveal segmentation algorithm to the image in which areas of the image are assigned to an object if the local contrast is greater than a minimum contrast value, wherein the minimum contrast value is defined with respect to the contrast in the image.

22. A method according to claim 21 wherein the minimum contrast is calculated from an average value of the local contrast in the image.

23. A method according to claim 21 wherein the local contrast is calculated from a weighted sum of the image intensities in the object and in the image.

24. A method according to claim 21 further comprising the steps of deriving a Gaussian derivative of the image and applying said foveal segmentation algorithm to the SMF image.

25. A method according to claim 19 wherein the average value of the local contrast in the image is calculated over the whole image.

26. A method according to claim 22 wherein the average value of the local contrast in the image is calculated over the whole image.

27. A method of processing images, comprising applying an anisotropic diffusion process to the image, the anisotropic diffusion process being adapted in dependence upon the contrast in the image, the method further comprising sementing the processed image using the foveal segmentation method of claim 21.

28. A method according to claim 16 wherein the image is an x-ray image.

29. A method according to claim 16 wherein the image is a medical image.

30. A method according to claim 16 wherein the image is a mammogram.

31. A method according to claim 30 further comprising the steps of identifying areas of the processed image as representing microcalcifications.

32. A method according to claim 21 wherein the image is an x-ray image.

33. A method according to claim 21 wherein the image is a medical image.

34. A method according to claim 21 wherein the image is a mammogram.

35. A method according to claim 34 further comprising the steps of identifying areas of the processed image as representing microcalcifications.
